(19) United States
(12) Patent Application Publication
(10) Pub. No.: US 2021/0272211 A1
(43) Pub. Date: Sep. 2, 2021

(54) SYSTEM AND METHOD FOR ISSUING AND TRADING CATASTROPHE BONDS

(71) Applicant: THE SECURE COMPANIES, INC., Atlanta, GA (US)

(72) Inventors: David Douglas DULEY, Atlanta, GA (US); Timothy Edward HILL, Grayslake, IL (US)

(73) Assignee: THE SECURE COMPANIES, INC., Atlanta, GA (US)

(21) Appl. No.: 17/254,152

(22) PCT Filed: Jun. 20, 2019
(86) PCT No.: PCT/US2019/038109

§ 371 Date: Dec. 18, 2020

Related U.S. Application Data
(60) Provisional application No. 62/687,572, filed on Jun. 20, 2018.

(51) Int. Cl. G06Q 40/08; G06Q 40/06

(52) U.S. Cl. CPC G06Q 40/08; G06Q 40/06

(57) ABSTRACT

A method includes receiving confirmation that an insurance policy was issued to a subscriber. The insurance policy is associated with a trigger event that would trigger a subscriber claim based on the policy. The method includes determining a plurality of factors that would affect an occurrence of the trigger event. The plurality of factors includes a political factor and an economic factor. The method also includes evaluating a likelihood of the trigger event occurring based on the plurality of factors and providing reinsurance to an issuer of the first insurance policy. The method also includes sponsoring a catastrophe bond to be offered to investors based on the trigger event.

### CROSS-REFERENCE TO RELATED APPLICATIONS

This international patent application claims priority to U.S. Patent Application No. 62/687,572 entitled “System and Method for Issuing and Trading Catastrophe Bonds,” filed Jun. 20, 2018.

### TECHNICAL FIELD

This invention relates to the field of systems and methods to provide reinsurance and more particularly, to systems and methods to issue catastrophe bonds relating to government or other defaults as triggering events.

### BACKGROUND

Catastrophe bonds are often used by the insurance industry to diversify risks that are largely undiversifiable. They accomplish this by transferring risk to the capital markets. They are used frequently in the property casualty insurance industry to provide a level of protection to insurers against events such as large hurricanes, wind storms or other natural disasters that can occur on a large scale.

Catastrophe bonds are typically set up to have a defined triggering event, like a defined wind speed in a specific area. If the defined trigger occurs, a portion or all of the catastrophe bond principal will be defaulted. The issuer of the catastrophe bond can then use the principal to pay the claims that arise from the specific event.

The catastrophe bond concept has never been applied to the non-diversifiable risk associated with political events that can have deleterious effects on investments or benefits. Accordingly, there is a need in the industry to develop systems and methods to issue such bonds.

### SUMMARY OF THE INVENTION

According to an aspect, this disclosure is directed to a method. The method may include receiving confirmation that an insurance policy was issued to a subscriber. The insurance policy may be associated with a trigger event that would trigger a subscriber claim based on the policy. The method may also include determining a plurality of factors that would affect an occurrence of the trigger event, the plurality of factors including a political factor and an economic factor. The method may include evaluating a likelihood of the trigger event occurring based on the plurality of factors. The method may also include providing reinsurance to an issuer of the first insurance policy and sponsoring a catastrophe bond to be offered to investors based on the trigger event.

In another aspect, this disclosure is directed to a system. The system may include a processor and memory storing instructions that cause the processor to effectuate operations. The operations may include receiving confirmation that an insurance policy was issued to a subscriber. The insurance policy may be associated with a trigger event that would trigger a subscriber claim based on the policy. The operations may include identifying a plurality of factors that would affect an occurrence of the trigger event, the plurality of factors including a political factor and an economic factor. The operations may also include modeling a likelihood of the trigger event occurring based upon the plurality of factors. The modeling may affect a catastrophe bond based on the trigger event.

### BRIEF DESCRIPTION OF THE DRAWINGS

The following detailed description of preferred embodiments is better understood when read in conjunction with the appended drawings. For the purposes of illustration, there is shown the drawings exemplary embodiments; however, the subject matter is not limited to the specific elements and instrumentalities disclosed.

FIG. 1 contains an exemplary system diagram showing the catastrophe bonds in connection with a system configured to provide insurance to program benefits.

FIG. 2 shows a block diagram of an exemplary application server.

FIG. 3 shows an exemplary bond offering in accordance with the present disclosure.

FIG. 4 shows an exemplary flow diagram of a method in accordance with the present disclosure.

FIG. 5 shows an exemplary flow diagram of a method in accordance with the present disclosure.

### DETAILED DESCRIPTION OF ILLUSTRATIVE EMBODIMENTS

Parametric Catastrophe Bonds. Parametric Catastrophe bonds may be offered to mitigate the risk associated with the insuring of benefits those from various programs. The parametric catastrophe bond may use a specifically defined index or measure as a trigger that is independent of the actual losses from the product. This may provide a simple, clearly defined structure to offer to investors. The trigger may, for example, include the passage of legislation signed into law or an executive order that authorizes a reduction in current or future benefits. The trigger may be a reduction in the benefits actually received by a policyholder relative to a previously determined or expected value, regardless of the cause. The trigger may be a delay in payment benefits relative to a pre-determined or expected timeline.

In an aspect, the indexed catastrophe bonds may be triggered based on a certain percentage of recipients having their benefits reduced or delayed. In another aspect, the bonds may be triggered based on a series of individual subscriber trigger events.

Indemnity Catastrophe Bonds. As an alternative or in addition to the parametric catastrophe bond discussed above, an indemnity catastrophe bond triggered by the insurer or reinsurer's actual loss. Thus, if the insurer or reinsurer is required to pay a claim, after a certain deductible is reached, the insurer or reinsurer may liquidate some or all of the at-risk capital of the bondholders.

Other Catastrophe Bonds. As a further alternative or in addition to the catastrophe bond types set forth above, other types of catastrophe bonds with a variety of triggers are contemplated by the present disclosure. For example, any risk-linked security instrument that transfers some or all of a particular risk to an investor from an insurer may be used. The bonds may be fixed rate or floating rate bonds.

Modeled loss catastrophe bonds may be used and may, for example, be based on an exposure portfolio constructed for use with catastrophe modeling software, and then when there is a triggering event, the event parameters are run against the exposure database in the model. If the modeled losses are above a specified threshold, the bond is triggered.

In another alternative, rather than a trigger based on any individual insurer's claims, the catastrophe bond may be triggered when the entire insurance industry loss from an event reaches a specified threshold. Thus, if there are insurers, reinsurers and catastrophe bonds, the trigger for the catastrophe bond may occur once the total loss meets or exceeds that threshold.

There may be modified index catastrophe bonds in which the trigger is linked to not only a trigger event such as the reduction of program-based benefits, but rather is linked to the sponsor's entire business losses. For example, the trigger may not occur initially upon the reduction in benefits, but may occur after both the reduction of benefits and a hurricane in South Florida. The modified index may weight the index results for various territories and lines of business.

Nesting of Triggers. It may be advantageous for a sponsor or set of sponsors of catastrophe bonds to model the triggers such that various triggers would be in place based on the risk assumed and coupon rate of the bonds. In that case, a first catastrophe bond offering with higher risk and return may be triggered based upon a reduction of benefits from an program reaching a certain percentage, (e.g., 5%), while a second catastrophe bond offering with a lower risk and return may be triggered when the reductions of benefits hit a higher percentage (e.g., 10%). In this way, the risk/return of such bonds may be modeled and adjusted to market conditions.

Other Triggering Events. The above trigger scenarios contemplate triggers based on a reduction of benefits. It is also within the scope of this disclosure for the trigger event to be based on a delay of benefits. Such delay may be based on an increase in the earliest retirement age. Alternatively, the trigger may be based on the payment of benefits being delayed for a period of time (e.g., 3 months) for budget or political or other reasons.

At a high level, this disclosure includes functionality for subscribers (e.g., insurance policies to mitigate the risk of a loss of benefits under a program) for insurers (e.g., for spreading the risk of those insurance policies to reinsurers), for reinsurers (e.g., to valuate and issue catastrophe bonds based on those insurance policies), and for investors (e.g., to trade those catastrophe bonds). The explanation that follows starts with subscriber functionality and progresses to explain the subsequent functionality for insurers, reinsurers, and investors in turn. While system 10 shows functionality for insurance subscribers, insurers, reinsurers, and the catastrophe bond market, it is contemplated by this disclosure that any single functionality or combination thereof can be implemented by this system 10 without affecting the operability thereof

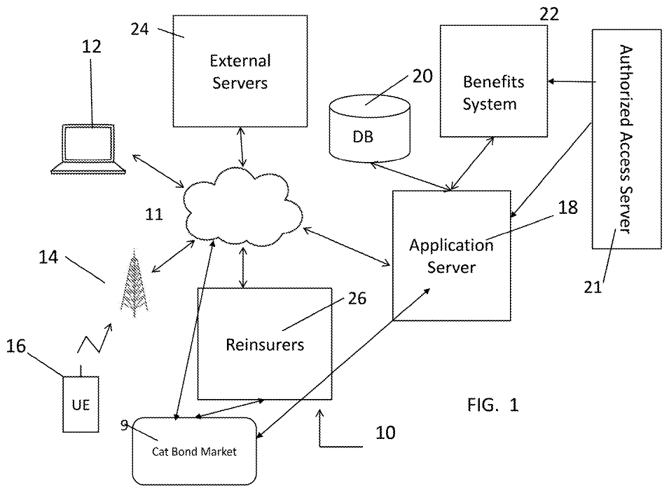

System Description. With respect to FIG. 1 there is shown an exemplary system 10 constructed in accordance with the present disclosure. System 10 may supports the various insurance products, including the pricing of premiums, enrollment of subscribers, administration of the program, collection of premiums, and payment of claims. On the insurer side, the present disclosure also provides for mitigation of the risk associated with providing the various insurance products, including establishing and dynamically assessing and modifying the underwriting criteria, providing for automatic collection of premiums, spreading the risk across multiple insurers and reinsurers, defining and maintaining the trigger criteria, and tracking and complying with various local, state and federal rules and regulations regarding such products.

With respect to current beneficiaries, the beneficiaries may subscribe to the insurance product and pay a monthly or other periodic premium in exchange for insurance that would cover losses or a portion of the losses that may be incurred due to a cut in benefits, such as those administered by benefits system 22. The premiums may be also be prepaid or upon reaching a certain level or cash value associated with the policy, be deemed fully paid-up. For example, the subscriber may choose a level of insurance coverage which may include coverage for a certain percentage of benefit cuts such as 5%, 10%, or 20% cuts. The level of insurance may be for a defined term, including 2 years, 5 years, or any other term. Like life insurance, the term may include a flat annual or monthly premium for the duration of a term. In a term-type policy, the rules engine may, for example, provide that a subscriber must be paying a premium when a claim for benefits is made for the claim to be a valid claim. This term-type policy may be useful for a subscriber that initially may need the insurance and then, at a later time, other financial instruments such as annuities or financial investments such as a retirement plan become available to the subscriber, reducing the need for the insurance product. The insurance may be purchased for the subscriber's lifetime and include level term payments.

The insurance benefits may be payable immediately upon a cut in benefits or may be phased in over time. There may be a deductible to be met prior to the payment of benefits. As stated above, the insurance product may be a term type of product which, unless renewed pursuant to the rules engine and underwriting criteria then in effect, expires upon the expiration of the term. Alternatively, the insurance product may have a cash accumulation component similar to a whole-life or variable life type policy. The cash accumulation component may reach a level wherein the interest earned on the cash value would cover the current and/or future premiums. The cash accumulation component may provide capital for loans against the policy or surrender value should the policy be cancelled. The policies may also include a death benefit.

With respect to future beneficiaries, future beneficiaries may subscribe to the insurance product even before any rights to entitlements to vest. Such subscribers may pay premiums while they are accruing rights in the entitlements program in exchange for insurance after they begin receiving such benefits.

In either case and as described in more detail below, the insurance product may be administered in a computer-implemented method and system that advances the technological arts in a computer network to enable large scale processing capabilities. Each of those networked elements is described in more detail below.

System Connectivity. The system 10 may include an input device 12, such as a desktop computer, a laptop computer, or a mobile device. The input device 12 may include an input device for a subscriber and may also include an input device for an administrator.

The network 11 may be an Internet Protocol/Multiprotocol Label Switching (IP/MPLS) converged network. The disclosure is applicable to any type of network 11, including but not limited to any type of wireless communication network, including 3G, fourth generation (4G)/LTE, fifth generation (5G), and any other wireless communication network, a public switched telephone network (“PSTN”), a wide-area local area network (“WLAN”) and may, for example include virtual private network (“VPN”) access points, Wi-Fi access points, and any other access points capable of interfacing with the network 11. It will be understood by those skilled in the art that while the network 11 may comprise the aforementioned networks, a combination of one or more communication networks may be used.

Alternative input devices represented by mobile user equipment 16 such as a smart phone, tablet, PDA or other portable user device in communication via a cellular or other wireless system, represented by cell tower 14, may also be used. Each of the input devices 12, 16 is in communication with application server 18 through network 11.

The UE 16 may, for example, be a smartphone, tablet or personal computer configured with an operating system which may, for example, be one of Apple's iOS, Google's Android, Microsoft Windows Mobile, or any other smartphone operating system or computer operating system or versions thereof The UE 16 may control user input functions, including, but not limited to, selection and control of inputs to system 10 and receipt of outputs from system 10. The UE 16 may provide the ability for a user to input billing information, profile information, emergency contacts, or other inputs that enable or personalize the functions available to a user. The UE 16 may include local client software for communication external servers 24 described in more detail below.

To communicate with the network 11, the UE 16 may have a communication interface for a wireless or wired communication system, which may, for example, be Wi-Fi, Bluetooth®, 3G, 46 LTE, and 5G, WiFi, LAN, WiLan or any other wireless communication system. The UE 16 may be in communication with an application server 18 through any of the above-identified systems. The functionality embedded and described in the disclosure may reside either on the UE 16 or the application server 18 or a combination thereof Any such designation of functionality between the UE 16 and server 18 may be a design choice or based on user experience, performance, cost, or any other factor. The allocation of functionality is exemplary only and non-limiting in scope of the present disclosure.

The UE 16 may be able to communicate across a communications interface with a variety of external servers 24 and/or other applications. Such external servers 24 may include resources of interest to subscribers, including, for example, benefits resources such as planning, health information, social media applications, and any other known or to be developed external applications. It will be understood by those skilled in the art that such external servers 24 may supply data to the UE 16 as well as receive data from the UE 16.

The UE 16 may access application server 18 to permit users of one or more of the UE 16 to enroll in the insurance programs contemplated by the present disclosure. Users of the UE 16 may access the application server 18 to inquire about the program, enroll in the program, set up automatic payments or make payments, monitor account status, and file claims in the event of a triggering event and any other functions made available to individual subscribers.

In addition to the UE 16 for accessing the application server 18, there may be an authorized access server 21 in communication with application server 18. The authorized access server 21 may, for example, provide an alternative means for subscribers to enroll in program benefits through the actions of authorized third parties. Authorized third parties may be financial planners, benefits administrators, advocacy groups licensed by a local, state or federal agency, insurers, or any third party working for or on behalf of subscribers. The authorized access server 21 may be a separate server or be integral with the application server 18, it being understood that some functionality of the authorized access server 21 may be implemented in the application server 18 and vice versa.

The authorized access server 21 may receive information regarding benefits, policyholders, and policy applicants from a variety of sources. the authorized access server 21 may accept financial records from a financial planning institution which may, for example, include retirement planning records. The financial records may include actual benefits or projections of benefits with respect to various programs. The authorized access server 21 may enable multiple enrollments of beneficiaries at a single time by an insurance company, a benefits administrator, a financial planner, sales agency or any other authorized third party representative of beneficiaries.

Application Server. The application server 18 may be in communication directly with one or more benefits systems 22 using VPN or other secure interface or alternatively, in communication with the benefits system 22 through network 11. The benefits system 22 may, for example, be a third-party system that administers programs. The benefits system 22 may provide relevant information on the micro level with respect to individual financials or on the macro level with respect to the overall financials of the benefits of the program it administers. For example, on the individual level, the benefits system 22 may include an individual's name and any previous names and/or aliases, identification, age, a history of eligibility for the program, like work history, payment history, or the like, current or expected amount of annual benefits, age at which benefits began or have been chosen to begin or if none, a default age at which benefits are set to begin, relatives, spouses, dependents, and any other individual information. On the macro level, the benefits system 22 may include data regarding current and historical revenue and disbursements, expected revenue and disbursements for current and future years, funded and unfunded obligations, past, current and projected balance sheets, reports on solvency, relevant legislation or administrative proceedings, and other information relevant to the program of the benefits system 22.

Application server 18 may also be in communication with database 20. The database 20 may include data such as individual subscriber data including name, unique identifiers, age, work history, family information such as spouse or dependents, eligibility factors for the program, trigger at which benefits started or are expected to start, the amount of current or projected benefits, and other individual information. Database 20 may also include the names of authorized individuals. It will be understood that not all individual data may be available for all individuals. Database 20 may be an external database, part of benefits system 22, an employer-employee database or a database custom developed to house benefit information.

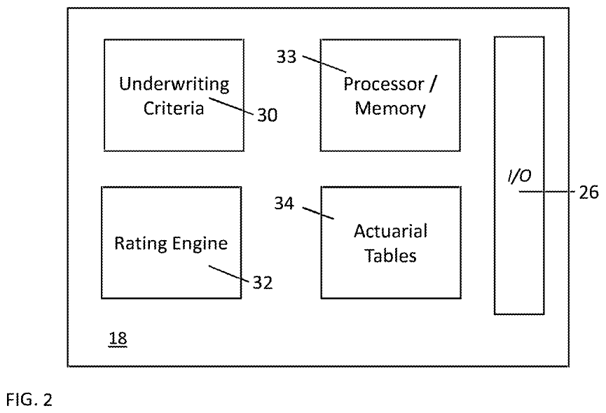

FIG. 2 shows an block diagram of the application server 18. The application server 18 may include a rating engine 32 (e.g., a processor and memory storing instructions that, when executed by the processor, effectuate operations) to perform functions for evaluating underwriting criteria and issuing insurance policies based on the subscriber's profile. It is anticipated that pricing of the insurance product will be a function of the age of the subscriber, a prediction or expectation of when the subscriber is anticipated to start receiving benefits, the credit rating of the subscriber, the type of policy, the expected benefits and other criteria. In the event that subscribers are currently receiving some or a portion of benefits under the program, the rating engine 32 may receive the current monthly value of those payments to subscribers. In the event that a subscriber is not yet receiving benefits, the rating engine 32 may calculate projected benefits that would be payable to subscribers. In an aspect, the application server may use an algorithm to determine the projected benefits based on a subscriber's salary history, inflation statistics, government policies and the like. The rating engine 32 may use artificial intelligence or rules-based algorithms to determine the projected benefits based on previous calculations, projections and benefits paid to other subscribers. For example, the application server 18 may use historical salary data from a set of subscribers that are in a particular industry (i.e., auto mechanics or high school teachers) and use that salary history to project future salary treatment of a similarly employed subscriber. The use of demographic and geographic data may also be used by the rating engine 32.

Underwriting Criteria. The application server 18 may use underwriting criteria 30 depending on whether the subscriber is a current recipient of benefits or a future recipient of benefits. The underwriting criteria 30 may be fixed or it may be dynamic based on timing of the policy applications, the number of current subscribers, the diversification of the risk, other system or program considerations, or even the political climate. The underwriting criteria 30 feeds into the ratings engine 32 to rate each subscriber's policy. Some of the underwriting criteria may, for example, include the following:

Age. There may be a minimum or a maximum age for a subscriber to apply for the insurance product. These ages could depend, for example, on the structure of the program, and whether benefits begin or expire based on the beneficiary's age.

Life Expectancy. The life expectancy may be derived from actuarial tables.

Current or expected monthly benefits. The system and method may calculate cost of living increases or decreases to benefits and factor that increase or decrease in either the premiums assessed, the benefits to be insured, or both. It will be understood that it is possible that there would be a cost of living decrease which would not trigger the payments of benefits unless specifically covered by the insurance product.

Current work status. Either the subscriber is a currently receiving benefits or a person expecting to receive benefits in the future.

Means testing. Entitlement programs may be need-based, or determined on other qualifiers. There may be means testing used to the extent that priority may be given to individuals that rely on the program for more of their cost of living than other individuals. Moreover, to the extent that means testing is used to calculate any taxes, those taxes may be used to determine the insured's baseline benefit amount and factor into an expected payout.

Risk assessment. The risk assessment includes an assessment of the current and projected financial state, solvency, and funding of the program. Risk assessment may also include factors related to government policy, political environment, and public opinion.

Ratio of premium to benefits. This ratio may assess the ability of the insurance pool to remain solvent and able to collect premiums and pay any claim.

Type of Policy. The present disclosure contemplates multiple policy types. For example, there may be a term policy which requires that a policy be current at the time a claim is made. Alternatively, the policy may be more like a whole-life policy which accumulates a cash value, or may be a combination of term and cash value accumulation policy.

Coverage requested by each subscriber. For example, the coverage requested may be selected from a cafeteria-type plan of options and may include coverage for a specific dollar amount, coverage for a percentage of the total benefits, full coverage for the total amount of benefits currently being received or expected to be received.

Indicators of future increases in benefits. For future recipients of program benefits, underwriting criteria may include projected salary and wage increases over the applicant's current income level based on occupation, age, education, and other factors, or other factors that may indicate an increase in eligibility for future benefits.

Probability of an eligibility change. The likelihood that certain factors, including, the subscriber's decision to opt-in to receiving benefits from the program at an earlier time, may also be considered.

Credit reports. Credit scores are often used by insurers to rate the risk associated with particular individuals. It may be possible that an individual's credit report factors into the underwriting criteria.

Reinsurance. System 10 may include a reinsurance server 26 which may, for example, be in communication with application server 18. There may be one or more reinsurance companies and each may have one or more servers in communication with system 10 through network 11. Each reinsurer may be granted limited, secure access to the system 10 depending on the reinsurer's role or position with respect to the systems and methods described in this disclosure. The interaction between the system 10 and the reinsurance servers 26 may include data communications involving risks, regulations, claims, investments, number of subscribers, revenue, invoicing, or any other data which may be relevant to a reinsurer.

Catastrophe bond market. The catastrophe bond market platform 9 may interface with reinsurer function 26 and application server 18. In an aspect, one or more reinsurers may be the sponsor of catastrophe bonds and offer the same to investors. The catastrophe bond market platform 9 may dynamically price the bonds based on market conditions including interest rates, the size of the offering, the types of triggering events and the likelihood of such triggering events, and other pricing criteria. The bonds may be offered at the same rate to all investors or be subject to open marketing bidding by one or more investors.

The catastrophe bond market platform 9 may be implemented by a general-purpose computer programmed to provide the functions of bond pricing, bidding, registration, coupons, and the like. The bond market functionality may also provide for the sale of the bonds on the secondary market. In that way, the catastrophe bond market platform 9 may act like a trading platform whose access is controlled by the one or more sponsors.

The catastrophe bond market platform 9 may include offerings and transactions to investors that are invited to access the platform. Such investors may be qualified investors, institutional investors, or an investor pool.

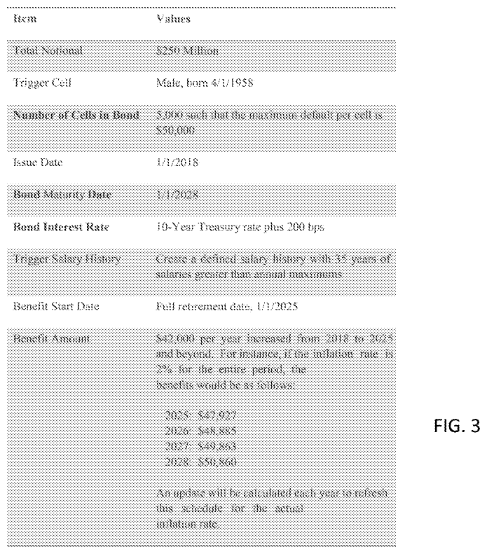

FIG. 3 illustrates an example of the structure of a catastrophe bond offering. In this example, the assumptions include that the trigger individual survives to full retirement age and then enter length of bond coverage. It further assumes that there is no status change. Access may be through terminals connected through network 11.

In this example, a default of a portion of principal will occur if there is a change to benefits resulting in a payment reduction to the sample trigger individual of more than 1% (to allow for minor calculation errors). If a Trigger event has occurred, the amount of defaulted principal will be defined as the difference between the projected payment (as described above and refreshed annually) and the actual payment to the Trigger individual times 5,000. If a Trigger Event occurs prior to the Bond Maturity Date, the Bond Maturity Date will be extended to Jun. 30, 2031. The interest rate credited to the outstanding notional will be increased by 300 bps but will not be payable until the earlier of Jun. 30, 2031 or the date principal is repaid. This provision gives the issuer the desired protection, but incents them to pay back the principal as soon as possible if protection is not deemed to be needed.

In this example, what is not insured is a payment reduction due to deflation or a payment reduction due to implementation of Universal Income or other fundamental changes to social welfare (e.g., entitlement) programs.

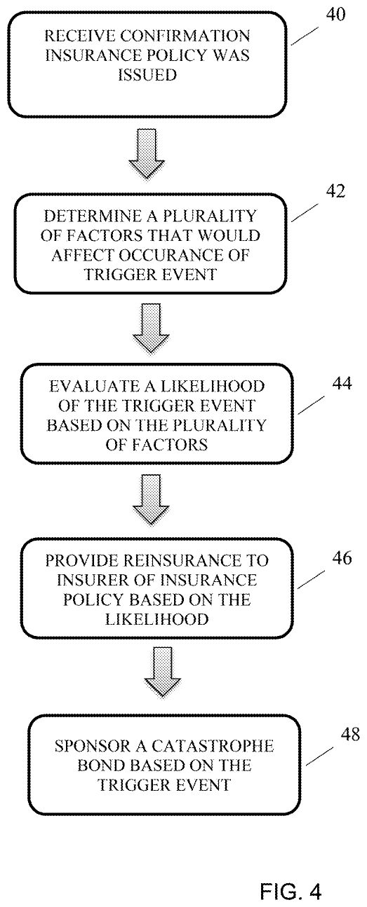

With reference to FIG. 4, there is shown an exemplary operational method of the catastrophe bond offering. At 40, the sponsor receives confirmation that an insurance policy was issued to a subscriber. This verification may be received from the insurer issuing the insurance policy. These verifications may be batched, so that each verification confirms issuance of multiple insurance policies. The verification may include details regarding the policy, including the coverage, the program, trigger event, and values associated with the policy. The verification may also include details regarding the subscribers, such as those details listed above with respect to the underwriting criteria. The sponsor may independently verify the insurance policies or other details included in the confirmation. For example, the sponsor may access a program-controlled database (e.g., benefits system 22) through a secure portal (e.g., authorized access server 21) to confirm the subscriber's eligibility or benefits amount under the program.

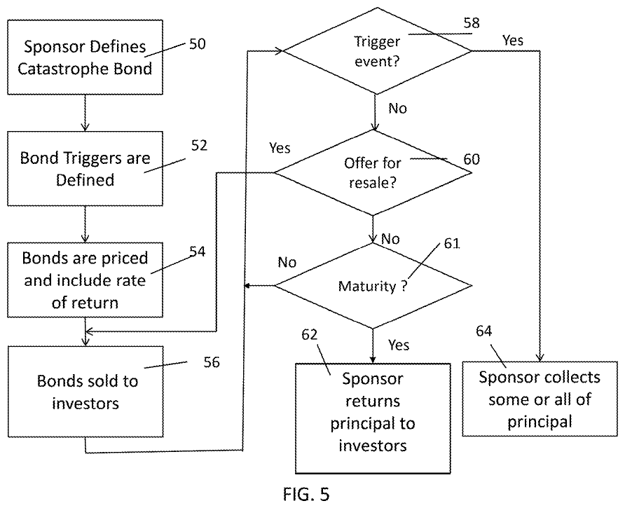

The trigger event would trigger a subscriber claim based on the policy. As described further herein, the trigger event may include a loss or decrease in benefits from a program for that subscriber, or another reduction in a financial status of the subscriber. At 42, the sponsor determines a plurality of factors that would affect the occurrence of the trigger event. Such factors may include the likelihood that a program would experience a decrease in funding, other cutbacks, or even be shut down altogether. In addition to other factors discussed herein, these factors may include economic factors, like a weakening of the economy in which the program operates or receives funding, which could be indicated by one or more financial market indexes or other measurements of the stock market. The plurality of factors may also include political factors, such as those that indicate the stability of the government or other entity sponsoring the program or those that indicate a likelihood in a legislative or other government action altering the functioning of the program. For example, upcoming elections that could alter the control of the legislative branch to a party that more favorably views such programs could indicate a decrease in the likelihood that a trigger event based on that program would occur. Similarly, the election of a government official (e.g., congressperson) could similarly affect the stability of the program. Thus, at 44, the sponsor may evaluate the likelihood of the trigger event occurring based on those factors. At step 46, the sponsor may provide reinsurance to the insurer of the insurance policy based on the likelihood of the trigger event occurring. Then, as explained in more detail with respect to FIG. 5, at 48, the sponsor may sponsor a catastrophe bond based on the trigger event and related to the reinsurance.

With reference to FIG. 5, there is shown an exemplary operational method of the catastrophe bond offering. At 50, the sponsor defines the type of bond to be issued, bond triggers are defined at 52 and bonds are priced at 54. This process may result in a bond offering similar to that in FIG. 3 and FIG. 4. At 56 the bonds are sold to investors. At 58, there is a decision point as to whether a trigger has occurred. If yes, at 64 the sponsor will retain some or all of the principal amount of the bond pursuant to the terms of the bond offering. If no trigger event has occurred, the investor may have the option of selling the bond on the secondary market to another investor. If that sale were to happen, the process continues at 56 wherein the bond is sold to the second investor. If that sale were not to happen and the bond holder retains the bond, then at 61 the decision is made as to whether the bond has reached maturity. If the bond has reached maturity, then the principal returned to the investor at 62. If the bond has not reached maturity, then the investor will hold the bond until a trigger event occurs, the bond is resold or until the bond reaches maturity.

It will be apparent to those skilled in the art that various modifications and variations may be made in the present disclosure without departing from the scope or spirit of the disclosure. Other aspects of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

The systems and methods of the present disclosure have been described in relation to the insurance of benefits. However, the scope of the disclosure extends beyond insurance of benefits and may, for example, include a system and method to provide private insurance to protect the beneficiaries of any federal, state, local and private pension funds. These products may be designed for an insurer to provide an insurance product to consumers to underwrite and hedge the receipt of retirement benefits.

The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method comprising:
receiving confirmation that an insurance policy was issued to a subscriber, the insurance policy associated with a trigger event that would trigger a subscriber claim based on the policy;
determining a plurality of factors that would affect an occurrence of the trigger event, the plurality of factors including a political factor and an economic factor, wherein the political factor comprises an identification of a political party controlling at least one branch of the United States government;
evaluating a likelihood of the trigger event occurring based on the plurality of factors;
providing reinsurance to an issuer of the insurance policy based on the likelihood of the trigger event; and
sponsoring a catastrophe bond to be offered to investors based on the likelihood of the trigger event.

2. The method of claim 1, wherein the political factor comprises an election of a government official associated with the political party.

3. The method of claim 1, wherein the trigger event comprises a reduction in a financial status of the subscriber.

4. The method of claim 4, further comprising verifying the financial status of the subscriber via a secure portal providing access to an externally-controlled database.

5. The method of claim 1, further comprising valuating the catastrophe bond based on the likelihood of the trigger event.

6. The method of claim 6, further comprising:
determining that a change affecting the plurality of factors has altered the likelihood of the trigger event occurring; and
revaluing the catastrophe bond based on the change.

7. The method of claim 1, wherein the policy insures against a decrease in financial benefits.

8. A system comprising:
a processor; and
memory storing instructions that cause the processor to effectuate operations, the operations comprising:
receiving confirmation that an insurance policy was issued to a subscriber, the insurance policy associated with a trigger event that would trigger a subscriber claim based on the policy;
identifying a plurality of factors that would affect an occurrence of the trigger event, the plurality of factors including a political factor and an economic factor, wherein the political factor comprises an identification of a political party controlling at least one branch of the United States government; and
evaluating a likelihood of the trigger event occurring based on the plurality of factors;
providing reinsurance to an issuer of the insurance policy based on the likelihood of the trigger event; and
sponsoring a catastrophe bond to be offered to investors based on the likelihood of the trigger event.

9. The system of claim 8, wherein the trigger event is a decrease in a financial status of the subscriber.

10. The system of claim 8, wherein the political factor comprises an election of a governmental official associated with the political party.

11. The system of claim 8, wherein the plurality of factors comprises an ordered sequence of events.

12. The system of claim 8, wherein the trigger event comprises a decrease in the financial status of the subscriber.

13. The system of claim 8, the operations further comprising verifying the financial status of the subscriber via a secure portal providing access to an external-controlled database.

14. The system of claim 8, wherein the plurality of factors comprises a characteristic of the subscriber.

15. The system of claim 14, wherein the characteristic of the subscriber is a predicted value of the subscriber claim.
